(19) United States
(12) Patent Application Publication
(10) Pub. No.: US 2026/0028454 A1
(43) Pub. Date: Jan. 29, 2026

(54) POLYCARBOSILANE FOR SILICON CARBIDE FIBERS, METHOD FOR PRODUCING SAME, AND METHOD FOR PRODUCING SILICON CARBIDE FIBERS

(71) Applicant: KUREHA CORPORATION, Tokyo (JP)

(72) Inventors: Ryota NAITO, Tokyo (JP); Junki SAITO, Tokyo (JP); Ryo IUCHI, Tokyo (JP); Koji YAMAKAWA, Tokyo (JP); Tatsuru GOTO, Tokyo (JP)

(73) Assignee: KUREHA CORPORATION, Tokyo (JP)

(21) Appl. No.: 19/112,504

(22) PCT Filed: Oct. 31, 2023
(86) PCT No.: PCT/JP2023/039177

§ 371 Date: Mar. 17, 2025

(30) Foreign Application Priority Data
Nov. 1, 2022 (JP) 2022-175726

(51) Int. Cl. C08G 77/60; D01F 9/10

(52) U.S. Cl. CPC C08G 77/60; D01F 9/10; D10B 2101/16

(57) ABSTRACT

Provided is a fiber material suitable for a method for producing a silicon carbide fiber with excellent mechanical properties. Polycarbosilane for silicon carbide fibers according to the present invention has a weight average molecular weight (Mw) of 10000 or more and 16000 or less, a number average molecular weight (Mn) of 1500 or more and less than 6000, and a ratio (Mw/Mn) of the weight average molecular weight (Mw) to the number average molecular weight (Mn) of 2.0 or more and less than 4.5 and is a reaction product from a composition containing a cyclic silane compound. In a method for producing the polycarbosilane for silicon carbide fibers according to the present invention, polycarbosilane is synthesized using a composition containing a cyclic silane compound, and the reaction product is subjected to molecular weight adjustment treatment.

### TECHNICAL FIELD

The present invention relates to a polycarbosilane for silicon carbide fibers, a method for producing the polycarbosilane for silicon carbide fibers, and a method for producing silicon carbide fibers.

### BACKGROUND ART

Silicon carbide fibers have lightweight, heat resistance, and high strength, and thus have been applied to heat engines, such as jet engines and gas turbines, as substitute materials for alloys.

A method for producing a silicon carbide fiber is known, for example, a method in which a polycarbosilane (hereinafter, “polycarbosilane” may also be described as “PCS”) as a precursor is used to prepare a PCS-infusibilized fiber, and the PCS-infusibilized fiber is heated at a temperature not exceeding 1000° C. in an inert gas atmosphere and then heated at a temperature of 1000 to 1500° C. in a mixed gas atmosphere of a hydrocarbon gas and an inert gas to produce a silicon carbide fiber (Patent Document 1). The PCS-infusibilized fiber is prepared by subjecting a PCS fiber to an infusibilization treatment in which the PCS fiber is oxidized by heating in air. However, such a PCS-infusibilized fiber contains a large amount of oxygen and thus has been accompanied by an issue in that a silicon carbide fiber obtained by pyrolyzing the PCS-infusibilized fiber has inferior heat resistance. To solve this issue, Patent Document 2 proposes a method of infusibilization through irradiation with a radiation in an oxygen-free atmosphere or in a vacuum. However, irradiation with a radiation requires expensive equipment and thus has been accompanied by an issue of increasing the production cost of a silicon carbide fiber.

In response to such an issue, Patent Document 3 proposes a method in which a molecular weight of PCS is adjusted to prepare a PCS with a high molecular weight that does not require infusibilization treatment, and a silicon carbide fiber is produced by dry spinning using the PCS. Patent Document 3 describes that a silicon carbide fiber with a tensile strength of 2.5 GPa or higher and a reduced fiber diameter of 5 to 9 μm is obtained by the method (paragraphs and [0075]).

### CITATION LIST

### Patent Document

Patent Document 1: JP H01-314730 A

Patent Document 2: JP H04-194028 A

Patent Document 3: JP 2019-137935 A

### SUMMARY OF INVENTION

### Technical Problem

However, the mechanical properties of the silicon carbide fiber produced by the method of Patent Document 3 cannot be said to be sufficient for practical use. The tensile strength of a silicon carbide fiber is a property greatly affected by defects present in the fiber. For the mechanism by which a silicon carbide fiber breaks, when an external force is applied to the silicon carbide fiber, stress is concentrated on defects in the fiber, and this leads to breakage of the fiber. Thus, when the structure other than the fiber diameter of the silicon carbide fiber is the same, the defect amount in the fiber is reduced by reducing the fiber diameter, and this improves the tensile strength of the fiber, as the defect amount per fiber decreases as the fiber diameter decreases. That is, the mechanical properties of the silicon carbide fiber tend to improve as the fiber diameter decreases, and tend to decrease as the fiber diameter increases.

On the other hand, for the production method, producing a fiber with a small fiber diameter requires using a thin spinning nozzle in the spinning step. Thus, this reduces the spinning amount of the fiber material per time and reduces the production amount of the fiber. Thus, reducing the fiber diameter can be a factor for increasing the production cost of the fiber. Thus, there is a demand for a production method that can provide a silicon carbide fiber with excellent mechanical properties, such as tensile strength, even though the silicon carbide fiber has a large fiber diameter. As described above, the mechanical properties of a silicon carbide fiber are largely related to the fiber material and the production method. Thus, an object of the present invention is to provide a fiber material suitable for a method for producing a silicon carbide fiber with excellent mechanical properties.

In view of the above issues, the present inventors have studied a method for preparing polycarbosilane (PCS), which is a precursor of silicon carbide. In the course of the study, the present inventors have found that a PCS obtained by using a composition containing a cyclic silane compound and carrying out a treatment for adjusting the molecular weight (hereinafter referred to as “molecular weight adjustment treatment”) is a fiber material suitable for a method for producing a silicon carbide fiber having high tensile strength and tensile elastic modulus, and have completed the present invention. Specifically, the present invention includes the following embodiments.

### Solution to Problem

(1) The present embodiment is a polycarbosilane for silicon carbide fibers, the polycarbosilane having a weight average molecular weight (Mw) of 10000 or more and 16000 or less, a number average molecular weight (Mn) of 1500 or more and less than 6000, and a ratio (Mw/Mn) of the weight average molecular weight (Mw) to the number average molecular weight (Mn) of 2.0 or more and less than 4.5, wherein the polycarbosilane is a thermolysis condensation reaction product from a composition containing a cyclic silane compound.

(2) The present embodiment is a method for producing the polycarbosilane for silicon carbide fibers described in the above (1), the method including:
(a) heating the composition at a first temperature of 300 to 600° C. in a liquid-phase reaction vessel to vaporize the composition;
(b) heating the composition in gaseous form obtained by the step (a) in a gas-phase heating region at a second temperature of 500 to 750° C., which is 5° C. or more higher than the first temperature, to produce a polycarbosilane;
(c) returning the polycarbosilane produced by the step (b) to the liquid-phase reaction vessel, and returning gaseous components having passed through the gas-phase heating region and cooled to the liquid-phase reaction vessel; and subsequently,
(d) heating the components returned to the liquid-phase reaction vessel at the first temperature to vaporize the components;
(e) heating compounds in gaseous form obtained by the step (d) in the gas-phase heating region at the second temperature to produce a polycarbosilane;
(f) returning the polycarbosilane produced by the step (e) to the liquid-phase reaction vessel, and returning gaseous components having passed through the gas-phase heating region and cooled to the liquid-phase reaction vessel; and
(g) after repeating each of the steps (d), (e), and (f), subjecting a resulting compound in the liquid-phase reaction vessel to a treatment of adjusting molecular weight.

(3) The present embodiment is the method for producing the polycarbosilane for silicon carbide fibers according to the above (1) or (2), in which the cyclic silane compound is dodecamethylcyclohexasilane.

(4) The present embodiment is a method for producing a silicon carbide fiber, the method including:
(I) spinning the polycarbosilane for silicon carbide fibers described in the above (1) to produce a polycarbosilane fiber; and
(II) pyrolyzing the polycarbosilane fiber in a non-oxidizing atmosphere to produce a silicon carbide fiber, in which the pyrolyzing step includes:
(i) pyrolyzing at 900° C. or higher and 1600° C. or lower; or
(ii) performing a primary pyrolyzing at 900° C. or higher and lower than 1200° C. and then a secondary pyrolyzing at 1200° C. or higher and 1600° C. or lower.

### Advantageous Effects of Invention

According to the present invention, there can be provided a PCS for silicon carbide fibers, the PCS being a fiber material suitable for producing a silicon carbide fiber with heat resistance and excellent mechanical properties. According to the present invention, there can be obtained a silicon carbide fiber with excellent mechanical properties even without applying an infusibilization treatment to the PCS fiber, thus contributing to a reduction in the production cost of the silicon carbide fiber.

### BRIEF DESCRIPTION OF THE DRAWINGS

FIG. 1 is a diagram schematically illustrating a liquid-phase/gas-phase thermolysis condensation apparatus used for synthesis of a polycarbosilane.

### DESCRIPTION OF EMBODIMENTS

Hereinafter, embodiments of the present invention will be specifically described. The present invention is not limited to the following embodiments and can be implemented with an appropriate modification within the scope of the objective of the present invention. In the present specification, the description “X to Y” (X and Y are any numerical values) means “X or more and Y or less” or “X or higher and Y or lower”.

### [1] Polycarbosilane for Silicon Carbide Fiber

A polycarbosilane for silicon carbide fibers according to the present embodiment is characterized by having a weight average molecular weight (Mw) of 10000 or more and 16000 or less, a number average molecular weight (Mn) of 1500 or more and less than 6000, and a ratio (Mw/Mn) of the weight average molecular weight (Mw) to the number average molecular weight (Mn) of 2.0 or more and less than 4.5 and being a thermolysis condensation reaction product from a cyclic silane compound.

The PCS for silicon carbide fibers according to the present embodiment is an organic substance corresponding to a “precursor” applied to the production of a silicon carbide fiber. In the present specification, the PCS formed into a fibrous shape is described as a “PCS fiber”, and a PCS fiber preliminarily pyrolyzed is described as a “pre-pyrolyzed PCS fiber”. The “silicon carbide fiber” according to the present embodiment is a silicon carbide fiber obtained by subjecting a PCS fiber to a pyrolyzing treatment to turn into ceramics.

For the PCS for silicon carbide fibers according to the present embodiment, optimum ranges are specified for features related to the molecular weight, and it is specified that the PCS is a reaction product from a cyclic silane compound. The PCS is a reaction product produced by thermal rearrangement and thermolysis condensation reaction of a cyclic silane compound used as a raw material. With these specific features, there can be provided a fiber material suitable for producing a silicon carbide fiber with heat resistance and excellent mechanical properties. A silicon carbide fiber can be produced by pyrolyzing a PCS fiber composed of the PCS without performing an infusibilization treatment. Furthermore, a silicon carbide fiber with high tensile strength and tensile elastic modulus are obtained. The resulting silicon carbide fiber has high tensile strength and tensile elastic modulus and has good mechanical properties also at a large fiber diameter.

In the production process of the silicon carbide fiber, the PCS as a fiber material is changed to silicon carbide. Along with this change, the bonding energy between the atoms increases, and this improves the mechanical properties (such as tensile strength and tensile elastic modulus) of silicon carbide. Thus, in theory, as the atomic ratio of carbon to silicon in silicon carbide is closer to the stoichiometric ratio, the mechanical properties of silicon carbide tend to improve.

On the other hand, in the case where oxygen atoms coexist in the course of a reaction in which PCS changes to silicon carbide, defects are known to occur due to release of CO gas or SiO gas (see Patent Document 2). In addition, in the production process of the silicon carbide fiber, along with crystal growth by the pyrolyzing treatment, distortion, voids, and/or the like occur in the crystal, and defects are formed. These defects cause a reduction in the mechanical properties of the silicon carbide fiber.

The present inventors have studied the issue of improving the mechanical properties of silicon carbide. In the course of the study, the present inventors have found that a silicon carbide fiber prepared from a PCS fiber in which PCS with a relatively large molecular weight (hereinafter referred to as the “large PCS”) and a PCS with a small molecular weight (hereinafter referred to as the “small PCS”) coexist has high mechanical properties. The detailed reason for that is not clear. The coexistence of the large PCS and the small PCS increases the degree of filling properties of the PCS in the PCS fiber. Furthermore, in the course of changing from PCS to silicon carbide, the large PCS forms a rigid skeleton structure by heating in the pyrolyzing treatment but on the other hand has a limitation in its molecular motion. Thus, this makes it difficult to eliminate a gap when the gap occurs between molecules. In contrast to that, in the small PCS, molecular motion by heating in the pyrolyzing treatment relatively easily takes place. It is presumed that in the case where the large PCS and the small PCS coexist, the gap between molecules occurring in the process of forming the rigid skeleton structure by the large PCS is filled by the small PCS, and as a result, crystallization of silicon carbide proceeds while an arrangement structure advantageous as a crystal structure of silicon carbide is formed. The silicon carbide fiber with high mechanical properties is considered to be obtained by such a mechanism.

In a PCS with too small a content ratio of the small PCS, large molecular motion would be difficult. As a result, it is presumed that crystal defects, such as voids, would be formed inside the silicon carbide fiber in the process of changing from the PCS to a silicon carbide crystal, and thus this would deteriorate the mechanical properties of the silicon carbide fiber. On the other hand, a PCS with too small a content ratio of the PCS with a large molecular weight would melt during the pyrolyzing treatment and thus is presumably difficult to form a fiber structure.

### Weight Average Molecular Weight (Mw)

The weight average molecular weight of the PCS is preferably in the range of 10000 or more and 16000 or less. With the weight average molecular weight of less than 10000, the SiC fiber would have lower tensile strength, and thus this is not preferred. Therefore, the weight average molecular weight of the PCS is preferably 10000 or more, more preferably 11000 or more, and even more preferably 12000 or more. On the other hand, a PCS with a weight average molecular weight of more than 16000 would require a large amount of solvent to dissolve the PCS in dry spinning, and thus this is not preferred. Hence, the weight average molecular weight of the PCS is preferably 16000 or less, more preferably 15000 or less, even more preferably 14500 or less, and particularly preferably 14000 or less.

### Number Average Molecular Weight (Mn)

The number average molecular weight (Mn) of the PCS is preferably in the range of 1500 or more and less than 6000. With the number average molecular weight of less than 1500, the PCS fiber may melt and fuse when the PCS fiber is pyrolyzed, and thus this is not preferred. Therefore, the number average molecular weight of the PCS is preferably 1500 or more, more preferably 2000 or more, and even more preferably 2500 or more. On the other hand, a PCS with a number average molecular weight of 6000 or more would require a large amount of solvent to dissolve the PCS in dry spinning, and thus this is not preferred. Thus, the number average molecular weight is preferably less than 6000, more preferably 4000 or less, even more preferably 3000 or less, and particularly preferably 2000 or less.

### Ratio of Weight Average Molecular Weight to Number Average Molecular Weight (Mw/Mn)

To increase the filling properties (filling rate) of the PCS molecules in the PCS fiber, it is important to appropriately adjust the molecular weight and the number of the large PCS molecules, the molecular weight and the number of the small PCS molecules, and each ratio in the molecular weight and the number. The “filling properties” and “filling rate” as used in the present specification are descriptions meaning similar properties. The weight average molecular weight (Mw) is largely reflected by the effect of the molecular weight distribution of the large PCS molecules, whereas the number average molecular weight (Mn) is largely reflected by the effect of the molecular weight distribution of the small PCS molecules. Thus, the ratio (Mw/Mn) of the weight average molecular weight to the number average molecular weight can be an index indicating the proportion of the large molecules and the small molecules in the PCS. By appropriately adjusting the ratio (Mw/Mn) of the PCS, the PCS fiber formed from the PCS can have increased filling properties of the PCS molecules in its inside. As a result, a silicon carbide fiber with excellent mechanical properties can be obtained by pyrolyzing the PCS fiber.

The ratio (Mw/Mn) of the weight average molecular weight to the number average molecular weight of the PCS is preferably in the range of 2.0 or more and less than 4.5. Hereinafter, in the present specification, the “ratio” may also be described as the “molecular weight ratio”. With the molecular weight ratio (Mw/Mn) of less than 2.0, a silicon carbide fiber obtained using this PCS would have lower tensile strength, and thus this is not preferred. Thus, the molecular weight ratio (Mw/Mn) is preferably 2.0 or more, more preferably 2.5 or more, and even more preferably 3.0 or more.

On the other hand, an increase in the molecular weight ratio (Mw/Mn) corresponds to a broadening of the molecular weight distribution. Excessive broadening of the molecular weight distribution of the PCS would reduce the filling properties of the PCS molecules in the PCS fiber and reduce the mechanical properties of the silicon carbide fiber prepared from the PCS fiber, and thus this is not preferred. Thus, the molecular weight ratio (Mw/Mn) is preferably less than 4.5, more preferably 4.0 or less, and particularly preferably 3.0 or less.

### Composition Containing Cyclic Silane Compound

PCS is usually produced using a polysilane compound as a raw material. Polysilane compounds have a skeleton in which Si atoms are connected to each other in a chain structure. In contrast to that, for the PCS for silicon carbide fibers according to the present embodiment, a composition containing a cyclic silane compound is used as a raw material for the PCS. Cyclic silane compounds have a skeleton in which Si atoms are connected to each other in a cyclic manner.

The composition containing a cyclic silane compound according to the present embodiment preferably contains a cyclic silane compound in an amount of 50 mass % or more, may contain a cyclic silane compound in an amount of 60 mass % or more, 80 mass % or more, or 90 mass % or more, or may contain a cyclic silane compound in an amount of 100 mass %. The “cyclic silane compound” is a compound in which a skeleton composed only of a Si-Si bond is a main chain and the main chain forms a ring. The number of members of the cyclic silane compound used in the method for producing the polycarbosilane is preferably 15 or less, more preferably 10 or less, and even more preferably 7 or less. The cyclic silane compound may have a single ring or a plurality of rings. The side chain of the cyclic silane compound may have any structure. Examples of the cyclic silane compound include octamethylcyclotetrasilane, decamethylcyclopentasilane, dodecamethylcyclohexasilane, and tetradecamethylcycloheptasilane. One or two or more compounds selected from the group of these cyclic silane compounds can be used. From the viewpoint of raw material supply, the cyclic silane compound is preferably dodecamethylcyclohexasilane.

The “composition” described above according to the present embodiment may contain a compound other than the cyclic silane compound. Examples of such a compound include dichlorodimethylsilane, which is a synthesis raw material for the cyclic silane compound, its decomposition condensate, and a chain polysilane compound.

On the other hand, PCSs with a smaller molecular weight tend to have a lower softening point. However, the present inventors have found that, for the PCS according to the present embodiment, a PCS fiber prepared even from a PCS with a small molecular weight does not melt in the pyrolyzing step and a silicon carbide fiber is obtained.

In the case of producing a silicon carbide fiber using the PCS fiber for silicon carbide fibers according to the present embodiment, the PCS fiber can be pyrolyzed without melting even without applying an infusibilization treatment to the PCS fiber, but the reason for this is not clear. The PCS according to the present embodiment has a specific molecular weight by subjecting the PCS produced from a cyclic silane compound to a molecular weight adjustment treatment. It is presumed that in the PCS fiber obtained by spinning the PCS, the molecular weight of the PCS increases in a short time in the pyrolyzing step, and thus the PCS fiber has not melted. The mechanism of such molecular weight increase is not clear. It is presumed that in the thermal rearrangement and thermolysis condensation reaction, in which the cyclic silane compound is ring-opened and changed to the PCS, both ends of the ring-opened molecular chain become active reaction points, and thus the resulting PCS has high reaction activity.

The PCS for silicon carbide fibers according to the present embodiment is characterized by being a reaction product obtained from a composition containing a cyclic silane compound and being a PCS with a specific molecular weight range and a specific molecular weight distribution. Spinning using the PCS with the appropriately controlled molecular weight distribution can increase the filling properties of PCS molecules in the PCS fiber. To increase the filling properties, the low molecular weight PCS needs to be allowed to coexist to a certain extent. On the other hand, the low molecular weight PCS tends to easily melt by heat treatment. The present inventors have found that by obtaining a PCS with a specific molecular weight range and molecular weight distribution from a cyclic silane compound contained in a raw material and using a PCS fiber obtained by spinning this PCS, a silicon carbide fiber with high mechanical properties can be obtained by pyrolyzing even without subjecting the PCS fiber to an infusibilization treatment.

### [2] Method for Producing Polycarbosilane for Silicon Carbide Fiber

A method for producing a polycarbosilane for silicon carbide fibers according to the present embodiment is a method for producing the polycarbosilane for silicon carbide fibers with characteristics of the above [1] and has the following features. The method includes:
(a) heating the composition containing the cyclic silane compound at a first temperature of 300 to 600° C. in a liquid-phase reaction vessel to vaporize the composition;
(b) heating the gaseous composition obtained by the step (a) in a gas-phase heating region at a second temperature of 500 to 750° C., which is 5° C. or more higher than the first temperature, to produce a polycarbosilane;
(c) returning the polycarbosilane produced by the step (b) to the liquid-phase reaction vessel, and returning gaseous components having passed through the gas-phase heating region and cooled to the liquid-phase reaction vessel; and subsequently,
(d) heating the components returned to the liquid-phase reaction vessel at the first temperature to vaporize the components;
(e) heating the gaseous compounds obtained by the step (d) in the gas-phase heating region at the second temperature to produce a polycarbosilane;
(f) returning the polycarbosilane produced by the step (e) to the liquid-phase reaction vessel, and returning gaseous components having passed through the gas-phase heating region and cooled to the liquid-phase reaction vessel; and
(g) after repeating each of the steps (d), (e), and (f), subjecting the resulting compound in the liquid-phase reaction vessel to a treatment of adjusting molecular weight.

The above production method can produce the polycarbosilane with a weight average molecular weight (Mw) of 10000 or more and 16000 or less, a number average molecular weight (Mn) of 1500 or more and less than 6000, and a ratio (Mw/Mn) of the weight average molecular weight (Mw) to the number average molecular weight (Mn) of 2.0 or more and less than 4.5.

### Liquid-Phase/Gas-Phase Thermolysis Condensation Apparatus

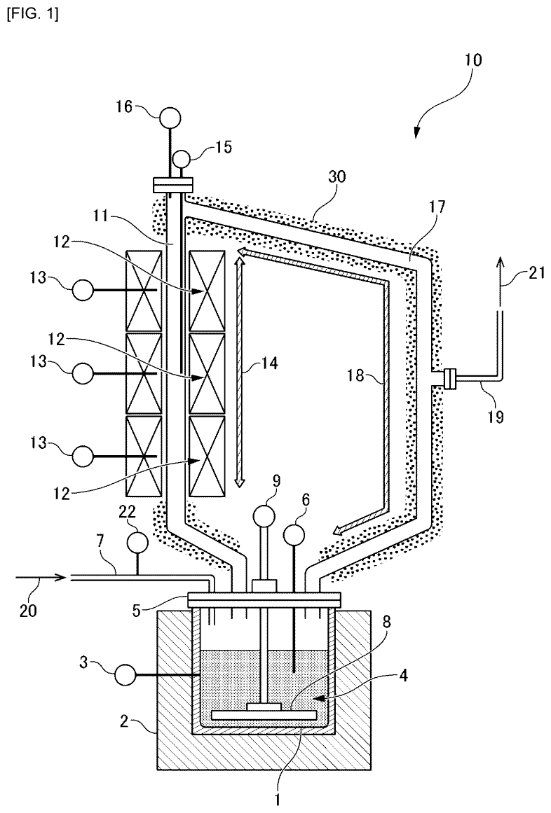

The polycarbosilane for silicon carbide fibers according to the present embodiment is preferably produced by utilizing liquid-phase/gas-phase thermolysis condensation reaction (which may hereinafter also be described simply as “thermolysis condensation reaction”). The PCS production by thermolysis condensation reaction can be carried out using, for example, a liquid-phase/gas-phase thermolysis condensation apparatus 10 (hereinafter described as a “thermolysis condensation apparatus”) schematically illustrated in FIG. 1. The thermolysis condensation apparatus 10 has, as main components, a liquid-phase reaction vessel 1, a flow path 11 for gas-phase heating (the flow path is hereinafter referred to as the “flow path for heating”), and a flow path 17 for gas-phase cooling (the flow path is hereinafter referred to as the “flow path for cooling”). The liquid-phase reaction vessel 1 is, for example, a cylindrical vessel having a bottom surface and is provided with a lid 5 for closing an opening at its upper side. The flow path 11 for heating and the flow path 17 for cooling have, for example, tubular structures.

### Liquid-Phase Reaction Vessel

The liquid-phase reaction vessel 1 contains in the inside a mixture 4 containing: a raw material composition including a cyclic silane compound; the PCS, a reaction product; and the like. To heat the mixture 4 to a given temperature (first temperature), a cylindrical liquid-phase heating means 2 is placed so as to surround the liquid-phase reaction vessel 1, and a temperature measuring device 3 (e.g., a thermocouple) for liquid-phase heating control is provided on the inner surface side of the liquid-phase heating means 2, the inner surface side facing the outer surface of the liquid-phase reaction vessel 1. The heating means is any means for heating the liquid phase in the liquid-phase reaction vessel, and for example, a heating device, such as a heating mantle, in which a heater and an exterior are integrated, can be used.

A stirring means having a stirring blade 8 and a motor 9 for driving, a liquid-phase temperature measuring device 6 (e.g., a thermocouple) for measuring the temperature of the mixture 4, and an inert gas inlet pipe 7 for supplying an inert gas 20 to the internal space of the liquid-phase reaction vessel 1 are attached with a lid 5 of the liquid-phase reaction vessel 1. The tip of the liquid-phase temperature measuring device 6 and the stirring blade 8 are arranged to be immersed in the liquid phase of the liquid-phase reaction vessel 1. It can be confirmed by the liquid-phase temperature measuring device 6 that the mixture 4 in the liquid-phase reaction vessel 1 is maintained at the first temperature. To measure the pressure of the liquid-phase reaction vessel 1, a pressure gauge 22 is installed onto the inert gas inlet pipe 7. Detecting the pressure in the liquid-phase reaction vessel 1 makes it possible, for example, to detect an abnormality in the internal pressure caused by blockage of the flow path 11 for heating, the flow path 17 for cooling, a gas discharge pipe 19, and the like.

### Gas-Phase Heating Region

One end of the flow path 11 for heating is connected to the liquid-phase reaction vessel 1 through the lid 5 of the liquid-phase reaction vessel 1. The component vaporized from the mixture 4 in the liquid-phase reaction vessel 1 moves to the flow path 11 for heating and is heated to a given temperature (second temperature) in a gas-phase heating region 14. As illustrated in FIG. 1, to heat the gas phase in the flow path 11 for heating, a gas-phase heating means 12 is arranged around the flow path 11 for heating. The gas-phase heating region 14 corresponds to a region heated by the gas-phase heating means 12 in the flow path 11 for heating. The gas-phase heating region is heated to produce an ascending air current in the flow path for heating, and thus the vapor containing the component vaporized from the inside of the liquid-phase reaction vessel is drawn into the flow path for heating by the chimney effect. As a result, a flow directed from the liquid-phase reaction vessel into the flow path for heating is formed. The inert gas introduced into the liquid-phase reaction vessel is also entrained by the flow and moved into the flow path for heating.

The structure of the gas-phase heating means 12 is not particularly limited, as long as the gas component in the flow path 11 for heating can be heated to a given temperature. As illustrated in FIG. 1, a segmented heater may be used. Controlling the segmented heater forms a wide soaking zone as the gas-phase heating region. The portion other than the portion where the gas-phase heating means 12 is provided around the flow path 11 for heating is preferably covered with a heat insulating material to keep warm so that the temperature does not decrease.

A temperature measuring device 13 for gas-phase heating control is installed on the inner surface side of the gas-phase heating means 12, the inner surface side facing the outer surface of the flow path 11 for heating. A temperature measuring device 15 (e.g., a thermocouple) for measuring the temperature of the gas-phase heating region 14 is inserted into the flow path 11 for heating from an end located on the opposite side of the end connected to the liquid-phase reaction vessel 1 in the flow path 11 for heating and is arranged so that the tip of the temperature measuring device 15 reaches the vicinity of nearly the center of the installation place of the gas-phase heating means 12.

A pressure gauge 16 for measuring the pressure of the gas phase in the flow path 11 for heating is attached to the above-described opposite end in the flow path 11 for heating. The pressure gauge 16 can detect, for example, an abnormality in the internal pressure caused by blockage and the like of the flow path 11 for heating, the flow path 17 for cooling, the gas discharge pipe 19, and the like. When the amount of vapor flowing from the liquid-phase reaction vessel 1 into the flow path 11 for heating needs to be controlled, a regulating valve may be provided on the way from the liquid-phase reaction vessel 1 to the gas-phase heating region 14 in the flow path 11 for heating.

### Cooling Region

The flow path 17 for cooling is connected to an opening located on the opposite side of the side connected to the liquid-phase reaction vessel 1 in the flow path 11 for heating. Among the components in the flow path 11 for heating, the components having passed through the gas-phase heating region 14, a high-molecular-weight PCS with a boiling point not lower than the second temperature condenses into liquid in the flow path 11 for heating and returns to the liquid-phase reaction vessel 1. The other gas components move from the flow path 11 for heating into the flow path 17 for cooling, are cooled in a cooling region 18 in the flow path 17 for cooling and turned to liquid, and then return to the liquid-phase reaction vessel 1. In the flow path 17 for cooling, almost the entire inside of the flow path 17 for cooling corresponds to the cooling region 18, and the vaporized components entering the cooling region 18 are gradually liquefied by heat dissipation from the flow path 17 for cooling.

If the temperature of the cooling region 18 were too low, the gas components in the flow path 17 for cooling would become a highly viscous liquid or solidify after turning to liquid, and this may block the flow path 17 for cooling. The liquid flowing through the flow path 17 for cooling is preferably cooled to a temperature range in which the liquid has a viscosity suitable for easy flow. Thus, the periphery of the flow path 17 for cooling may be covered with a heat insulating material or may be heated and kept warm as necessary.

In the components entering the cooling region 18, low-boiling components, such as hydrogen, methane, and monosilane, produced by the reaction in the gas-phase heating region 14 are also contained. The low-boiling components are discharged to the outside through the gas discharge pipe 19 provided at or near the center of the flow path 17 for cooling as discharge gas 21 together with the inert gas introduced from the inert gas inlet pipe 7. The discharge gas 21 is appropriately treated outside.

### Liquid-Phase/Gas-Phase Thermolysis Condensation Reaction

The polycarbosilane for silicon carbide fibers according to the present embodiment is produced based on liquid-phase/gas-phase thermolysis condensation reaction. Specifically, the polycarbosilane for silicon carbide fibers is produced through the following steps (a) to (g) described below. Hereinafter, each of the steps are described as the “step (a)” to “step (g)”.

### Step (a):

Step (a) is a step of heating a composition containing a cyclic silane compound at a first temperature of 300 to 600° C. in a liquid-phase reaction vessel to vaporize the composition. After the composition is put into the liquid-phase reaction vessel 1, the substance in the liquid-phase reaction vessel 1 is heated at the first temperature by the liquid-phase heating means 2, and the composition is vaporized. Then, the gaseous composition moves into the flow path 11 for heating. During heating, to prevent oxidation of the raw material, the inside of the liquid-phase reaction vessel 1 is preferably maintained in a non-oxidizing gas atmosphere. For example, as illustrated in FIG. 1, the atmosphere gas may be replaced by supplying the inert gas 20.

### Step (b):

Step (b) is a step of heating the composition in gaseous form obtained in the step (a) in the gas-phase heating region 14 at a second temperature of 500 to 750° C., which is 5° C. or more higher than the first temperature, to produce a PCS. The inside of the flow path 11 for heating is heated by the gas-phase heating means 12, and the gas-phase heating region 14 with a second temperature is formed. The gaseous cyclic silane compound vaporized by the step (a) and moved into the flow path 11 for heating undergoes gas-phase reactions of thermal rearrangement and thermolysis condensation in the gas-phase heating region 14, and a PCS is synthesized. The second temperature in the gas-phase heating region 14 is specified based on the temperature measured at or near the center of the gas-phase heating region 14.

### Step (c):

Step (c) is a process in which gaseous components containing the PCS produced by the step (b) are cooled and returned to the liquid-phase reaction vessel 1. The PCS produced by the gas-phase reaction in the step (b) is retained in the gas-phase heating region 14, and distribution occurs in the retention time. Thus, molecular weight distribution occurs also in the produced PCS, and the gaseous components contain PCSs with various molecular weights. Furthermore, in the reaction products produced in the gas-phase heating region 14, an unreacted cyclic silane compound, a degradation product of the cyclic silane compound, and the like are contained. Among these reactants, a high-molecular-weight PCS with a boiling point not lower than the second temperature condenses into liquid in the flow path 11 for heating and returns to the liquid-phase reaction vessel 1. The gaseous components containing the other reactants move from the flow path 11 for heating to the flow path 17 for cooling. Then, these components are cooled in the flow path 17 for cooling and turned to liquid, and then return to the liquid-phase reaction vessel 1.

### Step (d):

Step (d) carried out subsequently is a step of heating the components returned to the liquid-phase reaction vessel 1 at the first temperature to vaporize the components. The components returned to the liquid-phase reaction vessel 1 include the cyclic silane compound, a PCS with a low molecular weight, and a degradation product of the cyclic silane compound. The components are heated at the first temperature in the same manner as in the step (a). Among the components, a component with a boiling point lower than the first temperature is vaporized and moves to the flow path 11 for heating.

### Step (e):

Step (e) is a step of heating the gaseous compound obtained in the step (d) in the gas-phase heating region 14 at the second temperature to produce a PCS. The gaseous compound moved to the flow path 11 for heating by the step (d) undergoes thermal rearrangement and thermolysis condensation reaction in the gas-phase heating region 14 heated to the second temperature in the flow path 11 for heating in the same manner as in the step (b), and a PCS is synthesized.

### Step (f):

Step (f) is a process in which the polycarbosilane produced by the step (e) is returned to the liquid-phase reaction vessel 1, and the gaseous components having passed through the gas-phase heating region 14 are cooled and returned to the liquid-phase reaction vessel. In the same manner as in the step (c), among the PCSs produced by the step (e), a high-molecular-weight PCS with a boiling point not lower than the second temperature condenses and turns to liquid and returns to the liquid-phase reaction vessel 1. The other gaseous components move from the flow path 11 for heating to the flow path 17 for cooling, turn to liquid in the flow path 17 for cooling, and return to the liquid-phase reaction vessel 1.

Repetition of steps (d), (e), and (f):

Each of the steps (d), (e), and (f) are repeated, and the following are repeatedly performed accordingly: the vaporization of the low-boiling-point components in the liquid-phase reaction vessel 1, the production of a compound by thermal rearrangement and thermolysis condensation reaction in the gas-phase heating region 14, and the reflux of the reaction products in the gas-phase heating region 14 to the liquid-phase reaction vessel 1. As a result, the production of a PCS with a large molecular weight proceeds, and thus the content ratio of the high-molecular-weight PCS with a boiling point higher than the first temperature increases in the liquid-phase reaction vessel 1. On the other hand, the content ratio of the other components decreases. That is, the content ratio of the composition containing the cyclic silane compound, the degradation product of the composition, a PCS not satisfying the molecular weight giving a boiling point higher than the first temperature, and the like decreases. A PCS having achieved a given molecular weight is not vaporized at the first temperature in the liquid-phase reaction vessel 1, and thus this prevents an excessive increase in the molecular weight. A PCS with a given molecular weight can be selectively produced by controlling the first temperature in the liquid-phase reaction vessel 1 and the second temperature in the gas-phase heating region 14.

### Step (g):

Step (g) is a step of adjusting molecular weight in which, after repeating each of the steps (d), (e), and (f), subjecting the resulting compound in the liquid-phase reaction vessel to a treatment of adjusting molecular weight. The PCS prepared by the liquid-phase/gas-phase thermolysis condensation reaction has a molecular weight distribution including low-molecular-weight components to high-molecular-weight components. The molecular weight adjustment treatment is a sorting treatment for preventing fusion between fibers and melting even at a high temperature for pyrolyzing the PCS fiber by removing low-molecular-weight components causing fusion from the PCS and leaving high-molecular-weight components.

Specifically, the PCS is held in a state of being placed in a solvent for a given time. The type of solvent is not particularly limited as long as it can dissolve the PCS. Examples include ethyl acetate, acetone, and hexane. These solvents may be mixed. The molecular weight range of the low-molecular-weight components to be dissolved can be changed by changing the mixing ratio of the solvents.

The method for producing a PCS for silicon carbide fibers according to the present invention may include an additional step other than the liquid-phase/gas-phase thermolysis condensation method. The additional step is not particularly limited as long as the effects of the present invention are not impaired.

The method for producing a PCS for silicon carbide fibers according to the present embodiment uses a “composition containing a cyclic silane compound” as a raw material for the PCS.

### First Temperature

The first temperature is a temperature at which the substances contained in the liquid-phase reaction vessel are heated, and can be set in the range of 300° C. to 600° C. If the first temperature were lower than 300° C., a PCS with a low molecular weight would be difficult to vaporize, and thus this is not preferred. In addition, the vaporization rate of the substance would decrease, and the production rate of the PCS would decrease. Thus, this is not preferred. Thus, the first temperature is preferably 300° C. or higher, more preferably 400° C. or higher, and even more preferably 450° C. or higher. On the other hand, if the first temperature exceeded 600° C., a PCS with an excessively large molecular weight may be produced, and further the production ratio of the solidified material would increase. Thus, this is not preferred. Thus, the first temperature is preferably 600° C. or lower, more preferably 550° C. or lower, and even more preferably 500° C. or lower.

### Second Temperature

The second temperature is a temperature for heating in the gas-phase heating region in the flow path for heating and can be set in the range of 500° C. to 750° C. If the second temperature were lower than 500° C., the reaction rate of the thermal rearrangement and thermolysis condensation reaction of the PCS would decrease, thus leading to a decrease in the productivity and difficulty in producing a PCS with a high molecular weight. Thus, this is not preferred. Thus, the second temperature is preferably 500° C. or higher, more preferably 525° C. or higher, and even more preferably 550° C. or higher. On the other hand, if the second temperature were higher than 750° C., production of a solid material difficult to spin and the viscosity of the produced polycarbosilane would significantly increase. This may block the pipes of the production apparatus and thus is not preferred. Thus, the second temperature is preferably 750° C. or lower, more preferably 725° C. or lower, and even more preferably 700° C. or lower.

The second temperature needs to be in a range higher than the first temperature. In addition, the temperature difference between the second temperature and the first temperature can be set to 5° C. or more. If the temperature difference were less than 5° C., the progress of the thermal rearrangement and thermolysis condensation reaction in the gas-phase heating region would be slow, and thus this is not preferred. Thus, the temperature difference is preferably 5° C. or more, more preferably 30° C. or more, even more preferably 60° C. or more, and particularly preferably 90° C. or more.

### Heating Time

The treatment of heating the liquid-phase reaction vessel to the first temperature and the treatment of heating the gas-phase heating region of a gas-phase reaction tube to the second temperature are continued until the PCS achieves a given molecular weight. The time for producing the PCS with a target molecular weight varies depending on the type of cyclic silane compound used as a raw material, the first temperature, the second temperature, and the like. As the heating time increases, the molecular weight of the resulting PCS tends to increase. If the heating time were too short, the reaction time required for producing the PCS with a high molecular weight would be insufficient, failing to sufficiently obtain the PCS with a high molecular weight. Thus, according to the selected first temperature and second temperature, the heating time is preferably 4.0 hours or more, more preferably 5.0 hours or more, even more preferably 5.5 hours or more, particularly preferably 6.0 hours or more. The heat treatment may be performed continuously or dividedly. The heating time when the heating is performed dividedly is an accumulation of each heating time. On the other hand, after obtaining the PCS with a required given molecular weight, it is desirable to stop heating to reduce the cost required for heating. In the present specification, this heating time is also described as “reaction time”.

### Cooling Temperature

The reaction products having passed through the gas-phase heating region are cooled in the flow path for cooling. The cooling temperature is as low as the gaseous components can be cooled into liquid; if the cooling temperature were too low, the reactants would solidify, or the viscosity of liquid reactants would increase. This would block the inside of the path and thus is not preferred. The cooling temperature is preferably 50° C. or higher and 300° C. or lower. To maintain a given cooling temperature, the flow path for cooling may be kept warm.

### Non-Oxidizing Gas

The type of atmospheric gas in the liquid-phase reaction vessel is a non-oxidizing gas that does not react with the composition containing a cyclic silane compound and the reaction product, such as PCS, and is not particularly limited. For example, the atmospheric gas is preferably an inert gas, and nitrogen gas and/or a noble gas can be used alone or mixed and used.

The time for heating the liquid-phase reaction vessel and the gas-phase heating region to react can be appropriately adjusted according to the first temperature and the second temperature.

### [3] Method for Producing Silicon Carbide Fiber

A method for producing a silicon carbide fiber according to the present embodiment includes:
(I) spinning the polycarbosilane for silicon carbide fibers obtained by the method for producing a PCS for silicon carbide fibers in the above [2] to produce a polycarbosilane fiber; and
(II) pyrolyzing the polycarbosilane fiber in a non-oxidizing atmosphere to produce a silicon carbide fiber, in which the pyrolyzing step includes:
(i) pyrolyzing at 900° C. or higher and 1600° C. or lower; or
(ii) performing a primary pyrolyzing at 900° C. or higher and lower than 1200° C. and then a secondary pyrolyzing at 1200° C. or higher and 1600° C. or lower.

### Non-Oxidizing Gas

The type of non-oxidizing atmospheric gas in pyrolyzing is a non-oxidizing gas that does not react with the PCS fiber and is not particularly limited. For example, the atmospheric gas is preferably an inert gas, and nitrogen gas and/or a noble gas can be used alone or mixed and used.

### Spinning Step

The spinning step is a process of changing a PCS to fiber form. Examples of a usual spinning method include a melt spinning method, a dry spinning method, and a wet spinning method. A dry spinning method is preferably applied to the method for producing a silicon carbide fiber according to the present embodiment. The dry spinning method is a method in which a solvent is added to a precursor to prepare a precursor solution and spinning using the precursor solution. A PCS is dissolved in a solvent to prepare a solution for dry spinning, and the viscosity of the solution is adjusted. Then, the solution for dry spinning is charged to a spinning apparatus to prepare a PCS fiber.

The solvent in the solution for dry spinning, the solvent for dissolving a PCS, is any solvent that can dissolve a PCS and is not particularly limited. Examples include an aromatic hydrocarbon, such as benzene, toluene, ethylbenzene, xylene, and mesitylene; an aliphatic hydrocarbon, such as hexane, heptane, octane, and nonane; and a halogenated hydrocarbon, such as chloroform and dichloromethane. From the viewpoint of excellent solubility of a PCS and volatility, toluene or xylene is preferred.

The concentration of the solution for dry spinning can be appropriately adjusted. For example, the range of 50 to 70 wt. % can be selected for the concentration.

The solution viscosity of the solution for dry spinning can be appropriately adjusted according to the nozzle diameter of the spinning apparatus. For example, for a nozzle diameter of 65 μm, the solution viscosity at 25° C. is preferably from 10 to 30 Pa·s. The solution viscosity is determined by a known measurement method. The solution viscosity can be measured using, for example, an E-type viscometer.

A spinning apparatus and spinning conditions commonly used in the art can be charged to a spinning apparatus used in the spinning step. The solution for dry spinning is applied to a spinning apparatus and spun under conditions of, for example, a spinning nozzle diameter of 65 μm, a discharge pressure of 2 to 3.5 MPa, and an extrusion rate of the PCS solution of 10 to 30 mg/min, and a given PCS fiber can be obtained.

### Pyrolyzing Step

The method for producing a silicon carbide fiber according to the present embodiment includes a pyrolyzing step of pyrolyzing the PCS fiber in a non-oxidizing atmosphere to produce a silicon carbide fiber. The pyrolyzing step is a process of pyrolyzing the PCS fiber produced by the spinning step in a non-oxidizing atmosphere to turn into ceramics and obtaining a silicon carbide fiber accordingly.

The pyrolyzing step is preferably carried out by (i) pyrolyzing at 900° C. or higher and 1600° C. or lower, or performing (ii) a primary pyrolyzing at 900° C. or higher and lower than 1200° C. and then a secondary pyrolyzing at 1200° C. or higher and 1600° C. or lower. The silicon carbide fiber is preferably produced by these pyrolyzing treatments.

The pyrolyzing treatment (ii) is carried out in two stages of primary pyrolyzing and secondary pyrolyzing. The primary pyrolyzing in (ii) above is a treatment with the main purpose of pyrolyzing the PCS fiber at 900° C. or higher and lower than 1200° C. in a non-oxidizing atmosphere to eliminate hydrogen atoms and excess carbon atoms from the PCS and change the PCS fiber to a silicon carbide fiber. The primary pyrolyzing of the PCS fiber changes the PCS fiber to a silicon carbide (SiC) fiber, and the tensile strength of the fiber increases along with this chemical reaction. At lower than 900° C., the degree of change to silicon carbide would be insufficient, and the silicon carbide fiber would have lower tensile strength. Thus, the temperature of the primary pyrolyzing is preferably 900° C. or higher. In addition, from the viewpoint of achieving the object of the primary pyrolyzing, the temperature of the primary pyrolyzing may be set to lower than 1200° C.

The secondary pyrolyzing in (ii) above is a treatment with the main purpose of pyrolyzing the silicon carbide fiber at 1200° C. or higher and 1600° C. or lower in a non-oxidizing atmosphere to promote crystallization of silicon carbide and increase the strength. If the temperature exceeded 1600° C., crystallization would proceed excessively and the crystallite size would be too large, and thus the tensile elastic modulus of the fiber would increase, the fiber would be brittle, and the mechanical strength would start to decrease. Thus, the temperature of the secondary pyrolyzing is preferably 1600° C. or lower. In addition, from the viewpoint of allowing the secondary pyrolyzing to proceed efficiently, the secondary pyrolyzing temperature may be set to 1200° C. or higher.

The non-oxidizing gas atmosphere in the primary pyrolyzing is not particularly limited as long as it is such an atmosphere of a non-oxidizing gas as the PCS is not oxidized. For the non-oxidizing gas, nitrogen, a noble gas, or mixture thereof can be used. Silicon and nitrogen hardly react with each other in the heating temperature range of the primary pyrolyzing. The non- oxidizing atmosphere in the secondary pyrolyzing is not particularly limited as long as it is such a non-oxidizing atmosphere as silicon does not react. Silicon may react with nitrogen at a high temperature to be nitrided, the pyrolyzing treatment is preferably carried out in a noble gas, such as argon.

The pyrolyzing treatment of (i) above is a one-stage pyrolyzing treatment and is carried out in the temperature range of 900° C. or higher and 1600° C. or lower. According to the heated pyrolyzing temperature, the pyrolyzing includes stopping at the primary pyrolyzing of (ii) above or further reaching the secondary pyrolyzing of (ii) above. At the heating temperature corresponding to the primary pyrolyzing, a high tensile strength is obtained mainly by the change to the silicon carbide fiber. At the heating temperature corresponding to the secondary pyrolyzing, a higher tensile elastic modulus is obtained by the progress of crystallization of silicon carbide in addition to the change to the silicon carbide fiber.

For the pyrolyzing treatment of (i) above, a non-oxidizing gas atmosphere according to the heating temperature is employed. At the heating temperature corresponding to the primary pyrolyzing of (ii) above, nitrogen, a noble gas, or mixture thereof can be used so that the PCS is not oxidized. At the heating temperature corresponding to the secondary pyrolyzing of (ii) above, a noble gas, such as argon, or mixture thereof can be used so that silicon is not oxidized.

Before carrying out each pyrolyzing of (i) or (ii) above in the pyrolyzing step, preliminary pyrolyzing at 500° C. or higher and lower than 900° C. in a non-oxidizing atmosphere may be carried out. The preliminary pyrolyzing is a process of removing excess carbon atoms. The gas forming the non-oxidizing atmosphere is not particularly limited as long as it is a non-oxidizing gas. For the non-oxidizing gas, nitrogen, a noble gas, hydrogen, or mixture thereof can be used. If excess carbon were present in the silicon carbide fiber during its production process, carbon atoms would be eliminated by pyrolyzing, and this would be a cause for a decrease in the tensile strength of the silicon carbide fiber. Thus, it is desirable to reduce the excess carbon content in the pre-pyrolyzed PCS fiber before the primary pyrolyzing by mixing hydrogen in nitrogen or a noble gas as an atmospheric gas during the preliminary pyrolyzing. The content of hydrogen in the gas atmosphere in the preliminary pyrolyzing is preferably from 30 vol. % to 70 vol. % and more preferably from 50 vol. % to 70 vol. %.

### Mechanical Properties of Silicon Carbide Fiber

The silicon carbide fiber produced using the PCS for silicon carbide fibers according to the present embodiment has high tensile strength and tensile elastic modulus. For the tensile strength, a silicon carbide fiber with a tensile strength of 2.2 GPa or higher, 2.5 GPa or higher, 2.7 GPa or higher, 2.8 GPa or higher, or 2.9 GPa or higher can be obtained. For the tensile elastic modulus, a silicon carbide fiber with a high tensile elastic modulus of 210 GPa or higher, 230 GPa or higher, 260 GPa or higher, 300 GPa or higher, or 330 GPa or higher can be obtained.

Furthermore, the silicon carbide fiber according to the present embodiment has the above high tensile strength at a large fiber diameter (diameter) of 10.0 μm or more. As described above for the problem of the known art, the tensile strength of the silicon carbide fiber tends to decrease as the fiber diameter of the silicon carbide fiber increases. The silicon carbide fiber according to the present embodiment can provide a useful material in that it has excellent mechanical properties even though the silicon carbide fiber has a large fiber diameter.

### EXAMPLES

Hereinafter, examples of the present invention will be described. The scope of the present invention is not limited to the following description.

Methods for measuring physical property values of molecular weight, solution viscosity, tensile strength, tensile elastic modulus, and fiber diameter will be described below. The physical property values according to the present invention and examples are based on numerical values obtained by these measurement methods.

### Molecular Weight

The weight average molecular weight (Mw) and the number average molecular weight (Mn) were measured in accordance with the method specified in JIS K7252-1:2016 (ISO16014-1:2012). Specifically, the molecular weight of a PCS was measured using a liquid chromatograph (HPLC available from Shimadzu Corporation) and columns available from Showa Denko K.K. (one each of KF-604, KF-602, and KF-601 were used with connected in this order from the pump side). Toluene was used as a measurement solvent, the sample concentration was set to 0.5 wt. %, the flow rate to the analytical part and the reference was set to 0.40 mL/min, and the temperature of the oven was set to 40° C., and then the molecular weight was measured using a differential refractometer as a detector.

### Solution Viscosity

The viscosity of a solution for dry spinning was measured using an E-type viscosimeter (ARES-G2 available from TA Instruments, Inc.) under the conditions of a test jig of a φ25-mm stainless steel parallel plate, a thicknesses of the solutions of 0.5 mm, a temperature of 25° C., and a shear rate of 200 sec⁻¹.

### Tensile Strength and Tensile Elastic Modulus

The tensile strength and tensile elastic modulus of a silicon carbide fiber were measured according to the measurement method of JIS R7606: 2000. Ten filaments of a silicon carbide fiber were randomly selected, the tensile strength and tensile elastic modulus of each silicon carbide filament were measured, and a value obtained by averaging the resulting measured values of the ten filaments were used.

### Fiber Diameter

For the fiber diameter, the diameter of the silicon carbide fiber was measured at a magnification of 2000 times with an optical microscope (VHX-5000) available from Keyence Corporation using 10 filaments of the fiber provided for the measurements of the tensile strength and tensile elastic modulus, and a numerical value obtained by averaging the resulting measured values was used.

### Example 1

### (1) Production of PCS for Silicon Carbide Fiber

A polycarbosilane (PCS) was produced using a thermolysis condensation apparatus 10 as illustrated in FIG. 1. First, dodecamethylcyclohexasilane (DMCHS) as a raw material cyclic silane compound was placed into the liquid-phase reaction vessel 1. The temperature in the liquid-phase reaction vessel 1 is hereinafter referred to as “the first temperature”. For the first temperature, 485° C. was selected. The inside of the liquid-phase reaction vessel 1 was heated at the first temperature, and the cyclic silane compound was vaporized. The vaporized cyclic silane compound moved into the flow path 11 for heating and was passed through the gas-phase heating region 14. The temperature of the gas-phase heating region 14 is hereinafter referred to as “the second temperature”. For the second temperature, 600° C. was selected. The gas-phase heating region 14 was heated at the second temperature, and PCSs with various molecular weights were produced by thermal rearrangement and thermolysis condensation reaction of the cyclic silane compound in the gas-phase heating region 14.

Substances in the flow path 11 for heating passed through the gas-phase heating region 14 and then moved to the flow path 17 for cooling. Among the

PCSs produced in the gas-phase heating region 14, a high-molecular-weight PCS with a boiling point not lower than the second temperature condensed into liquid in the flow path 11 for heating and returned to the liquid-phase reaction vessel 1. Gaseous components other than the above-described high-molecular-weight PCS were cooled in the flow path 17 for cooling and returned to the liquid-phase reaction vessel 1.

The components, an unreacted cyclic silane compound, and the like having returned to the liquid-phase reaction vessel 1 were vaporized again in the liquid-phase reaction vessel 1 heated to the first temperature. The vaporized cyclic silane compound moved to the flow path 11 for heating and produced a PCS in the gas-phase heating region 14 heated to the second temperature. Furthermore, the increase in molecular weight of the PCS progressed. Among the PCSs with a high molecular weight produced in the flow path 11 for heating, a high-molecular-weight PCS with a boiling point not lower than the second temperature was condensed and returned to the liquid-phase reaction vessel 1, and the gaseous components having passed through the gas-phase heating region 14 were cooled in the flow path 17 for cooling and returned to the liquid-phase reaction vessel 1. A circular reaction was thus carried out, in which the cyclic silane compound was heated and vaporized in the liquid-phase reaction vessel, the PCS was produced and the increase in molecular weight of the PCS progressed in the gas-phase heating region, and the condensed components returned to the liquid-phase reaction vessel.

The treatment of heating the liquid-phase reaction vessel to the first temperature and the treatment of heating the gas-phase heating region to the second temperature were carried out for a heating time (hereinafter referred to as “reaction time”) of 6.3 hours, and the above circular reaction was continued. Thereafter, heating was stopped, and the liquid-phase reaction vessel and the flow path for cooling were allowed to cool to room temperature, and a polycarbosilane (PCS) with a predetermined molecular weight was obtained in the liquid-phase reaction vessel.

The resulting PCS was further subjected to a molecular weight adjustment treatment described below. Ethyl acetate having a mass five times that of the PCS was added to the PCS to prepare a mixture. The mixture was then heated and stirred at 50° C., and then the liquid was removed. This operation was repeated four times, and a PCS with a low molecular weight dissolved in ethyl acetate was removed accordingly. Then, ethyl acetate was removed from the remaining mixture, and a PCS was obtained.

### (2) Preparation of PCS Fiber

The resulting PCS was dissolved in xylene as a solvent, and a solution for dry spinning was prepared. A solidified material and the like in the solution were removed by filtration, then a fiber extruded from the spinneret (nozzle) with a nozzle diameter of 65 μm using the solution was wound, and a PCS fiber was obtained.

### (3) Preparation of Silicon Carbide Fiber

The PCS fiber was pyrolyzed according to the following procedure, and a silicon carbide fiber was prepared. For the PCS fiber, the temperature was increased to 500° C. at a rate of 150° C./h in a nitrogen atmosphere. Thereafter, preliminary pyrolyzing was carried out by increasing the temperature from 500° C. to 800° C. at a rate of 100° C./h in a mixed gas atmosphere containing 40 vol. % of argon gas and 60 vol. % of hydrogen gas. Then, in an argon gas atmosphere, the temperature was increased from 800° C. to 1000° C. at a rate of 150° C./h and then maintained at 1000° C. for 1 hour to carry out pyrolyzing. After the pyrolyzing, heating was stopped, and the temperature was allowed to drop to room temperature, and a silicon carbide fiber was obtained.

The production conditions and the physical property values of the PCS are shown in Table 1. The physical property values of the solution for dry spinning of the PCS and the physical property values of the resulting silicon carbide fiber are shown in Table 2.

### Example 2

A silicon carbide fiber was obtained by the same procedure as in Example 1 except that for the PCS fiber produced in Example 1, the temperature was increased from 800° C. to 1400° C. at a rate of 150° C./h and then maintained at 1400° C. for 1 hour.

### Example 3

The first temperature for the PCS production was set to 475° C., the second temperature was set to 650° C., and the reaction time was set to 4.4 hours, then a

PCS was produced by the same procedure as in Example 1. Then the molecular weight adjustment treatment with ethyl acetate was performed four times on the resulting PCS. Then, 8-fold mass of hexane was added to the treated PCS to prepare a mixture. The mixture was stirred at room temperature (25° C.), and then a PCS with a low molecular weight dissolved in hexane was removed by removing the liquid. Then, hexane was removed from the remaining mixture, and a PCS with an adjusted molecular weight was obtained. A silicon carbide fiber was prepared using the resulting PCS by the same procedure as in Example 1.

### Example 4

A PCS with an adjusted molecular weight and a silicon carbide fiber were obtained by the same procedure as in Example 1 except that the reaction time for the PCS production was 6.5 hours.

### Example 5

A silicon carbide fiber was obtained using the PCS fiber prepared in Example 4 by the same procedure as in Example 2.

### Example 6

A PCS with an adjusted molecular weight was obtained by the same procedure as in Example 1 except that the first temperature for the PCS production was 480° C., the reaction time was 6.0 hours, a mixed solvent composed of 70 mass % of acetone and 30 mass % of hexane was used as the solvent for the molecular weight adjustment treatment, and the molecular weight adjustment was performed once.

### Example 7

A PCS with an adjusted molecular weight was obtained by the same procedure as in Example 6 except that a mixed solvent composed of 80 mass % of acetone and 20 mass % of hexane was used as the solvent for the molecular weight adjustment treatment.

### Example 8

The silicon carbide fiber produced in Example 1 was further subjected to heat treatment. The silicon carbide fiber of Example 1 was obtained by pyrolyzing at 1000° C. and thus corresponds to those subjected to the primary pyrolyzing.

The secondary pyrolyzing was carried out using the silicon carbide fiber by increasing the temperature to 1000° C. at a rate of 150° C./h in a nitrogen atmosphere, then increasing the temperature from 1000° C. to 1400° C. at a rate of 150° C./h in an argon gas atmosphere, and then maintaining the temperature at 1400° C. for 1 hour. After the secondary pyrolyzing, heating was stopped, and the temperature was allowed to drop to room temperature, and a silicon carbide fiber was obtained.

### Example 9

A PCS with an adjusted molecular weight and a silicon carbide fiber were obtained by the same procedure as in Example 1 except that a cyclic silane mixture (containing 89.7 wt. % of dodecamethylcyclohexasilane (DMCHS), 6.9 wt. % of decamethylcyclopentasilane (DMCPS), and 1.9 wt. % of tetradecamethylcycloheptasilane (TDMCHS)) was used instead of dodecamethylcyclohexasilane (DMCHS) and the reaction time for the PCS production was 5.0 hours.

### Comparative Example 1

A PCS with an adjusted molecular weight and a silicon carbide fiber were obtained by the same procedure as in Example 1 except that a poly (dimethylsilane)

(PDMS) was used instead of dodecamethylcyclohexasilane (DMCHS) and the reaction time for the PCS production was 5.0 hours.

### Comparative Example 2

A PCS with an adjusted molecular weight and a silicon carbide fiber were obtained by the same procedure as in Comparative Example 1 except that the reaction time for the PCS production was 8.0 hours.

### Comparative Example 3

A PCS and a silicon carbide fiber were obtained by the same procedure as in Example 1 except that for the PCS production, the first temperature was 480° C. and the reaction time was 6.0 hours, and the molecular weight adjustment treatment was not carried out.

### Comparative Example 4

A PCS with an adjusted molecular weight and a silicon carbide fiber were obtained by the same procedure as in Example 1 except that for the PCS production, the first temperature was 475° C. and the reaction time was 5.0 hours.

For the resulting silicon carbide fibers obtained in the above examples and comparative examples, weight average molecular weight, number average molecular weight, solution viscosity (Pas), fiber diameter (μm), tensile strength (GPa), and tensile elastic modulus (GPa) were measured by the given measurement methods. The solution viscosity (Pa·s) of the solution for dry spinning, the diameter (μm) of the PCS fiber, and the diameter (μm) of the silicon carbide fiber were measured by the given measurement methods. The solution concentration (wt. %) of the solution for dry spinning was calculated from the blending ratio. These results are shown in Tables 1 and 2.

In the column of “Molecular weight adjusting solvent” in Table 1, “EtOAc” is ethyl acetate, “n-H” is n-hexane, “ACE” is acetone, “80% ACE/20% n-H” is a mixed solvent of 80 mass % of acetone and 20 mass % of n-hexane, and “70% ACE/30% n-H” is a mixed solvent of 70 mass % of acetone and 30 mass % of n-hexane.

The pyrolyzing treatment of Examples 1 to 5 and Comparative Examples 1 to 4 corresponds to the one-stage treatment of (i) in the present embodiment, and the pyrolyzing temperature is shown in the column of “pyrolyzing temperature” in Table 2. The pyrolyzing treatment of Example 8 corresponds to the two-stage treatment of (ii) in the present embodiment, and each temperature of the primary pyrolyzing and the secondary pyrolyzing is shown in the column of “pyrolyzing temperature” Table 2.

TABLE 1

| | | | | | | | Weight | Number | |
|---|---|---|---|---|---|---|---|---|---|
| | | | | | Molecular | Number of | average | average | Molecular |
| | | First | Second | Reaction | weight | molecular | molecular | molecular | weight |
| | Silane | temperature | temperature | time | adjusting | weight | weight | weight | ratio |
| | compound | (° C.) | (° C.) | (h) | solvent | adjustment | (Mw) | (Mn) | (Mw/Mn) |
| Example 1 | DMCHS | 485 | 600 | 6.3 | EtOAc | 4 | 13048 | 4701 | 2.78 |
| Example 2 | DMCHS | 485 | 600 | 6.3 | EtOAc | 4 | 13048 | 4701 | 2.78 |
| Example 3 | DMCHS | 475 | 650 | 4.4 | EtOAc, | 4 + 1 | 12731 | 5966 | 2.13 |
| | | | | | n-H | | | | |
| Example 4 | DMCHS | 485 | 600 | 6.5 | EtOAc | 4 | 13969 | 4749 | 2.94 |
| Example 5 | DMCHS | 485 | 600 | 6.5 | EtOAc | 4 | 13969 | 4749 | 2.94 |
| Example 6 | DMCHS | 480 | 600 | 6.0 | 70% ACE/ | 1 | 12312 | 3347 | 3.68 |
| | | | | | 30% n-H | | | | |
| Example 7 | DMCHS | 480 | 600 | 6.0 | 80% ACE/ | 1 | 11002 | 2566 | 4.29 |
| | | | | | 20% n-H | | | | |
| Example 8 | DMCHS | 485 | 600 | 6.3 | EtOAc | 4 | 13048 | 4701 | 2.78 |
| Example 9 | DMCHS | 485 | 600 | 5.0 | EtOAc | 4 | 12747 | 4987 | 2.56 |
| | 89.7 wt. % | | | | | | | | |
| | DMCPS | | | | | | | | |
| | 6.9 wt. % | | | | | | | | |
| | TDMCHS | | | | | | | | |
| | 1.9 wt. % | | | | | | | | |
| Comparative | PDMS | 485 | 600 | 5.0 | EtOAc | 4 | 9830 | 6105 | 1.61 |
| Example 1 | | | | | | | | | |
| Comparative | PDMS | 485 | 600 | 8.0 | EtOAc | 4 | 14225 | 5988 | 2.38 |
| Example 2 | | | | | | | | | |
| Comparative | DMCHS | 480 | 600 | 6.0 | — | — | 10630 | 1726 | 6.16 |
| Example 3 | | | | | | | | | |
| Comparative | DMCHS | 475 | 600 | 5.0 | EtOAc | 4 | 8368 | 5123 | 1.63 |
| Example 4 | | | | | | | | | |

TABLE 2

| | | | | | | | Tensile |
|---|---|---|---|---|---|---|---|
| | Solution | Solution | | PCS fiber | SiC fiber | Tensile | elastic |
| | concentration | viscosity | Pyrolyzing | diameter | diameter | strength | modulus |
| | (wt. %) | (Pa · s) | temperature | (μm) | (μm) | (GPa) | (GPa) |
| Example 1 | 56.3 | 18.3 | 1000 | 18.3 | 10.8 | 2.92 | 244 |
| Example 2 | 56.3 | 18.3 | 1400 | 18.3 | 10.0 | 2.69 | 338 |
| Example 3 | 54.0 | 14.9 | 1000 | 17.5 | 10.6 | 2.71 | 262 |
| Example 4 | 55.2 | 20.0 | 1000 | 17.8 | 10.8 | 2.88 | 237 |
| Example 5 | 55.2 | 20.0 | 1400 | 17.8 | 10.5 | 2.80 | 346 |
| Example 8 | 56.3 | 18.3 | 1000 | 18.3 | 10.0 | 2.97 | 353 |
| | | | 1400 | | | | |
| Example 9 | 58.7 | 16.5 | 1000 | 18.4 | 11.4 | 2.35 | 217 |
| Comparative Example 1 | 56.0 | 17.9 | 1000 | 18.3 | 10.9 | 1.91 | 252 |
| Comparative Example 2 | 54.4 | 17.6 | 1000 | 17.7 | 10.1 | 1.93 | 247 |
| Comparative Example 3 | 64.1 | 18.5 | 1000 | 17.9 | 9.6 | 2.18 | 245 |
| Comparative Example 4 | 56.3 | 20.2 | 1000 | 17.8 | 10.5 | 1.76 | 251 |

### Evaluation

In Examples 1 to 9, which are included in the scope of the present invention, the molecular weight adjustment treatment was carried out, and a PCS with a molecular weight included in the scope of the present invention was prepared. Among these, the silicon carbide fibers obtained by pyrolyzing the PCS fibers of Examples 1 to 5, 8, and 9 exhibited high numerical values in tensile strength and tensile elastic modulus, and had good mechanical properties. The silicon carbide fibers of Examples 2, 5, and 8 were obtained by pyrolyzing at a pyrolyzing temperature higher than that of the other examples. As a result, crystallization proceeded, and thus the tensile elastic modulus increased.

In Comparative Examples 1 and 2, the PCS was prepared using a poly (dimethylsilane) (PDMS), which is a chain silane compound, instead of a cyclic silane compound as a raw material for the PCS production. The number average molecular weight (Mn) of the PCS of Comparative Example 1 was in a range higher than that of the present invention, whereas the weight average molecular weight (Mw) and the molecular weight ratio (Mw/Mn) were in a range lower than that of the present invention. The weight average molecular weight, the number average molecular weight, and the molecular weight ratio of the PCS of Comparative Example 2 were included in the scope of the present invention. The silicon carbide fibers each obtained using the PCS fiber composed of each PCS of Comparative Examples 1 and 2 had a tensile strength in the range of less than 2.2 GPa and exhibited lower mechanical properties than the silicon carbide fibers of Examples 1 to 5, 8, and 9.

In Comparative Examples 3 and 4, the PCS was prepared using a cyclic silane compound as a raw material. The molecular weight ratio (Mw/Mn) of the PCS of Comparative Example 3 was in a range higher than that of the present invention. The weight average molecular weight (Mw) and the molecular weight ratio of the PCS of Comparative Example 4 were in ranges lower than those of the present invention. The silicon carbide fibers each obtained by pyrolyzing the PCS fiber composed of each PCS of Comparative Examples 3and 4 had a tensile strength in the range of less than 2.2 GPa and exhibited lower mechanical properties than the silicon carbide fibers of Examples 1 to 5, 8, and 9.

According to the above, the present invention showed a useful effect in terms of being able to provide a PCS for silicon carbide fibers, the PCS being a fiber material suitable for producing a silicon carbide fiber with heat resistance and excellent mechanical properties. Furthermore, the present invention showed a useful effect in terms of being able to produce a silicon carbide fiber with heat resistance and excellent mechanical properties even without applying an infusibilization treatment to the PCS fiber.

### REFERENCE SIGNS LIST

1 Liquid-phase reaction vessel
2 Liquid-phase heating means
3 Temperature measuring device for liquid-phase heating control
4 Mixture
5 Lid
6 Liquid-phase temperature measuring device
7 Inert gas inlet pipe
8 Stirring blade
9 Motor for driving
10 Liquid-phase/gas-phase thermolysis condensation apparatus
11 Flow path for gas-phase heating
12 Gas-phase heating means
13 Temperature measuring device for heating control
14 Gas-phase heating region
15 Temperature measuring device
16 Pressure gauge
17 Flow path for gas-phase cooling
18 Cooling region
19 Gas discharge pipe
20 Inert gas
21 Discharge gas
22 Pressure gauge
30 Heat insulating material

1-4. (canceled)

5. A polycarbosilane for silicon carbide fibers, the polycarbosilane having a weight average molecular weight (Mw) of 10000 or more and 16000 or less, a number average molecular weight (Mn) of 1500 or more and less than 6000, and a ratio (Mw/Mn) of the weight average molecular weight (Mw) to the number average molecular weight (Mn) of 2.0 or more and less than 4.5, wherein the polycarbosilane is a reaction product from a composition comprising a cyclic silane compound.

6. A method for producing the polycarbosilane for silicon carbide fibers described in claim 5, the method comprising:
(a) heating the composition at a first temperature of 300 to 600° C. in a liquid-phase reaction vessel to vaporize the composition;
(b) heating the composition in gaseous form obtained by the step (a) in a gas-phase heating region at a second temperature of 500 to 750° C., which is 5° C. or more higher than the first temperature, to produce a polycarbosilane;
(c) returning the polycarbosilane produced by the step (b) to the liquid-phase reaction vessel, and returning gaseous components having passed through the gas-phase heating region and cooled to the liquid-phase reaction vessel; and subsequently,
(d) heating the components returned to the liquid-phase reaction vessel at the first temperature to vaporize the components;
(e) heating a compound in gaseous form obtained by the step (d) in the gas-phase heating region at the second temperature to produce a polycarbosilane;
(f) returning the polycarbosilane produced by the step (e) to the liquid-phase reaction vessel, and returning gaseous components having passed through the gas-phase heating region and cooled to the liquid-phase reaction vessel; and
(g) after repeating each of the steps (d), (e), and (f), subjecting a resulting compound in the liquid-phase reaction vessel to a treatment of adjusting molecular weight.

7. The method for producing the polycarbosilane for silicon carbide fibers according to claim 5, wherein the cyclic silane compound is dodecamethylcyclohexasilane.

8. The method for producing the polycarbosilane for silicon carbide fibers according to claim 6, wherein the cyclic silane compound is dodecamethylcyclohexasilane.

9. A method for producing silicon carbide fibers, the method comprising:
(I) spinning the polycarbosilane for silicon carbide fibers described in claim 5 to produce a polycarbosilane fiber; and
(II) pyrolyzing the polycarbosilane fiber in a non-oxidizing atmosphere to produce a silicon carbide fiber, wherein the pyrolyzing step comprises:
(i) pyrolyzing at 900° C. or higher and 1600° C. or lower; or
(ii) performing a primary pyrolyzing at 900° C. or higher and lower than 1200° C. and then a secondary pyrolyzing at 1200° C. or higher and 1600° C. or lower.
